(19) United States
(12) Patent Application Publication
(10) Pub. No.: US 2006/0239763 A1
(43) Pub. Date: Oct. 26, 2006

(54) Paper-guiding device, image forming apparatus having the same, and method thereof

(76) Inventor: Tae-young Lee, Suwon-si (KR)

Correspondence Address: STANZIONE & KIM, LLP, 919 18TH STREET, N.W., SUITE 440, WASHINGTON, DC, 20006, US

(21) Appl. No.: 11/384,543

(22) Filed: Mar. 21, 2006

(30) Foreign Application Priority Data
Apr. 22, 2005 (KR) 2005-33443

(51) Int. Cl. B42F 13/00

(52) U.S. Cl. 402/79

(57) ABSTRACT

A paper-guiding device, an image forming apparatus having the same, and a method thereof. The paper-guiding device includes at least one paper guide movably disposed at a paper tray to line up and hold printing papers, a guide conveying unit to convey the at least one paper guide, and a position adjusting unit to control operations of the guide conveying unit, to detect a position of the at least one paper guide and to control a stop position of the at least one paper guide based on the detected position of the at least one paper guide.

### CROSS-REFERENCE TO RELATED APPLICATIONS

This application claims the benefit under 35 U.S.C. §119(a) of Korean Patent Application No. 2005-33443, filed on Apr. 22, 2005, the entire content of which is incorporated herein by reference.

### BACKGROUND OF THE INVENTION

1. Field of the Invention

The present general inventive concept relates to an image forming apparatus such as an ink-jet printer, a multifunctional device, or a laser printer, and more particularly, to a paper-guiding device used in a paper feeder to guide a printing paper (or recording medium) to be fed, an image forming apparatus having the same, and a method thereof.

2. Description of the Related Art

An image forming apparatus (i.e., an ink-jet printer, a multifunctional device, and a laser printer) generally includes a paper feeder for feeding a printing paper. The paper feeder includes a paper cassette or a paper tray and a paper-guiding device in the paper tray. The paper cassette or the paper tray loads printing papers. The paper-guiding device is able to line up and hold printing papers of different sizes and guide the printing papers of the different sizes to be fed without skew.

FIG. 1 is a view illustrating a multifunctional device 1 having a conventional paper-guiding device 20, and FIG. 2 is a detailed view illustrating the conventional paper-guiding device 20. FIG. 3 is a cross-sectional view illustrating the conventional paper-guiding device 20 of FIG. 2 along a line I-I′.

As illustrated in FIGS. 1 and 2, the paper-guiding device 20 includes a paper guide 21 movably disposed at an inner holder 14 of a paper tray 10. That is, the paper guide 21 is shifted in a right direction A and a left direction B along the inner holder 14.

The paper guide 21 includes an adjustment guide unit 22, an adjustment tab 24, a locking unit 28, and a movable guide unit 32.

The adjustment guide unit 22 includes a guiding surface 23, which is a vertical wall, to guide one edge of the printing paper.

The adjustment tab 24 is disposed at a top front portion of the adjustment guide unit 22. The adjustment tab 24 horizontally extends from the adjustment guide unit 22 and projects in an upward direction.

The locking unit 28 includes a locking release tab 29, a locking protrusion 30 illustrated in FIG. 3, and a locking guide protrusion 31 that engages the locking protrusion 30. The locking release tab 29 is disposed above the top front portion of the adjustment guide unit 22 being separated from the adjustment tab 24 by a predetermined distance. A first groove and a second groove 34 (one shown) are formed at both sides of the locking release tab 29 to lift up a bottom portion 29a of the locking release tab 29 when a user grips the locking release tab 29.

As illustrated in FIG. 3, the locking protrusion 30 is a single protrusion formed on the bottom portion 29a of the locking release tab 29. The locking guide protrusion 31 has a saw-tooth shape and includes a plurality of protrusions. The locking guide protrusion 31 is formed on a front portion of the inner holder 14 in a horizontal direction to face and engage the locking protrusion 30. The locking protrusion 30 is lifted up with the bottom portion 29a of the locking release tab 29 when the user grips the locking release tab 29. As a result, the locking protrusion 30 is separated from the locking guide protrusion 31. The locking protrusion 30 is returned to the original position with the bottom portion 29a when the user releases the grip of the locking release tab 29. As a result, the locking protrusion 30 is in gear with (i.e., engages) the locking guide protrusion 31.

As illustrated in FIG. 3, the movable guide unit 32 of FIG. 2 has a shape of ‘ [symbol] ’. The movable guide unit 32 is disposed under the adjustment guide unit 22 and is integrally coupled to the adjustment guide unit 22. The movable guide unit 32 shifts along a space formed between a back portion of an outer holder 12 of the paper tray 10 and an open portion 18 of the inner holder 14 in the right direction A and the left direction B. The outer holder 12 is coupled to a main body frame 15 through hinges 13 and 13′ that are disposed at the back portion and on both sides of the outer holder 12.

As illustrated in FIG. 2, a long guiding protrusion 33 is formed on a bottom inner surface of the movable guide unit 32, and a long guiding groove 16 is formed in the inner holder 14 in parallel with the locking guide protrusion 31. The long guiding protrusion 33 is inserted into the guide groove 16. When the paper guide 21 lines up and holds one edge of the printing paper, the long guiding protrusion 33 prevents tilting of the printing paper by transferring a force supplied to one end of the guiding surface 23 of the adjustment guide unit 22 to the other end of the guiding surface 23.

Hereinafter, operations of the conventional paper-guiding device 20 will be described.

At first, a plurality of printing papers is loaded on the outer and the inner holders 12 and 14 of the paper tray 10.

Then, when the user grips the locking release tab 29 and the adjustment tab 24 together to push the locking release tab 29 toward the adjustment tab 24, the bottom portion 29a of the locking release tab 29 is lifted up with the locking protrusion 30. As a result, the locking protrusion 30 is separated from the locking guide protrusion 31.

After separating the locking protrusion 30 from the locking guide protrusion 31, the long guiding protrusion 33 of the movable guide unit 32 can be shifted along the guide groove 16. That is, the paper guide 21 is shifted in the right direction A illustrated in FIG. 2 to reach one edge of the printing papers.

When the guiding surface 23 of the adjustment guide unit 22 reaches the one edge of the printing papers, the guiding surface 23 pushes the one edge of the printing papers to the right direction A. As a result, the printing papers are lined up between the guiding surface 23 and a first inner wall 17 of the inner holder 14. Herein, the first inner wall 17 is a reference wall used to line up the printing papers.

When the user releases the adjustment tab 24 and the locking release tab 29 after lining up the printing papers, the bottom portion 29a of the locking release tab 29 is returned to the original position and the locking protrusion 30 is geared in (i.e., engages) the locking guide protrusion 31 again. As a result, the printing papers are lined up and held in the lined up position.

The printing paper is then guided along the first inner wall 17 and the guiding surface 23 and picked up by a pick-up roller of a pickup roller assembly (not shown). The picked up paper is conveyed to an image forming unit (not shown) for forming image on the picked up paper.

As described above, the user must manually shift the paper guide 21 of the conventional paper guiding device 20 to line up the printing papers and to hold the printing papers in the lined up position.

Since the user must manually lock and un-lock the paper-guiding device 20 in a proper position through gearing of the locking protrusion 30 and the locking guide protrusion 31 using physical force, it is difficult to lock and to release the locking protrusion 30 and the locking guide protrusion 31. Also, elements of the paper guiding device 20 are often broken by the physical force while releasing and locking the paper-guiding device 20. In particular, if the locking protrusion 30 and the locking guide protrusion 31 are manufactured to be geared together (i.e., engage each other) too tightly due to a design error or a manufacturing error, the user must firmly and forcefully grip the locking release tab 29 to free the locking protrusion 30 from the locking guide protrusion 31. The user may also shift the paper guiding device 20 without completely separating the locking protrusion 30 from the locking guide protrusion 31. In this case, the elements of the paper-guiding device 20 (i.e., the locking release tab 29, the locking protrusion 30, and the locking guide protrusion 31) may be broken.

Additionally, since the user manually shifts the paper guide 21 of the conventional paper guiding device 20, operation precision is also degraded. As a result, the stack of printing paper may not be precisely lined up between the guiding surface 23 and the first inner wall 17.

If the stack of the printing paper is not precisely lined up and held in the paper tray 10, the printing paper is improperly picked up. That is, the printing paper is tilted and skewed and is picked up to form images on the printing paper such that the printing quality is degraded.

### SUMMARY OF THE INVENTION

Accordingly, the present general inventive concept provides a paper-guiding device to automatically line up printing papers and hold a position of the lined up printing papers, an image forming apparatus having the same, and a method thereof.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a paper-guiding device usable in an image forming apparatus, including at least one paper guide movably disposed at a paper tray to line up and hold printing papers on the paper tray, a guide conveying unit to convey the at least one paper guide along the paper tray, and a position adjusting unit to control operations of the guide conveying unit, to detect a position of the at least one paper guide and to control a stop position of the at least one paper guide based on the detected position thereof.

The guide conveying unit may include a motor, a pinion disposed at a driving shaft of the motor, and a rack connected to the at least one paper guide to transfer a rotation force of the pinion to the at least one paper guide and being geared in the pinion.

The position adjusting unit may include a paper detecting sensor to detect whether the printing papers are loaded in the paper tray, a position detecting sensor disposed at the at least one paper guide to be operated by the printing paper according to a movement of the at least one paper guide to detect the position of the at least one paper guide, and a controller to control the guide conveying unit to convey the at least one paper guide according to signals output from the paper detecting sensor and the position detecting sensor, and to control the guide conveying unit to control the stop position of the at least one paper guide according to the signals output from the position detecting sensor while the at least one paper guide is being conveyed.

The paper detecting sensor and the position detecting sensor may be a photo sensor.

The position detecting sensor may include a sensing unit disposed at the at least one paper guide and having a light-emitting unit and a light-receiving unit, and an actuator having an sensing end movably disposed between the light-emitting unit and the light-receiving unit, an operating end having at least one end surface projecting from the at least one paper guide by a first predetermined distance “d,” and a support rod connecting the sensing end and the operating end to be rotatable together.

The operating end may be formed as a pentagon shape.

The first predetermined distance “d” may be in a range of about 0.5 to 1.5 mm.

The controller may control the guide conveying unit to convey the at least one paper guide to a first direction to contact the printing paper when the paper detecting sensor outputs a first ON-signal and the position detecting sensor outputs a second OFF-signal, and controls the guide conveying unit to adjust the stop position of the at least one paper guide when the at least one paper guide comes in contact with the printing paper to cause the position detecting sensor to generate a second ON-signal.

If a predetermined time has not elapsed since the image forming apparatus is turned on when the paper detecting sensor generates the first ON-signal and the position detecting sensor outputs the second ON-signal, the controller may control the guide conveying unit to convey the at least one paper guide to the first direction and control the guide conveying unit to adjust the stop position of the at least one paper guide when the at least one paper guide comes in contact with the printing paper to cause the position detecting sensor to output the second ON signal.

The stop position of the at least one paper guide may be determined according to whether the position detecting sensor generates the second ON-signal again after when the at least one paper guide comes in contact with the printing paper to cause the position detecting sensor to output the second ON-signal, the at least one paper guide is shifted to the first direction by a second predetermined distance “x”, shifted to a second direction which is opposite to the first direction by about two times the second predetermined distance “x,” and then shifted to the first direction again by about the second predetermined distance “x.”

The second predetermined distance “x” corresponds to an allowable line up error of the printing paper, and may be in a range of about 2 to 5 mm.

The paper-guiding device may further include at least one stopper disposed at the paper tray to restrict the at least one paper guide from being shifted passed a waiting position when the at least one paper guide reaches the waiting position which is a position in which the at least one paper guide awaits loading of printing papers to the paper tray, and to operate the position detecting sensor at the same time, and the controller controls the guide conveying unit to shift the at least one paper guide to the second direction where the at least one paper guide contacts the stopper when the paper detecting sensor outputs the first OFF signal and the position detecting sensor outputs the second OFF signal, and controls the guide conveying unit to stop the at least one paper guide when the at least one paper guide comes in contact with the stopper to cause the position detecting sensor to output the second ON signal.

The foregoing and/or other aspects of the present general inventive concept may also be achieved by providing a paper guiding device usable with an image forming apparatus, the device comprising a paper tray, a paper guide movable along the paper tray to hold sheets of recording medium in a predetermined position, a sensing unit to detect a state of the paper tray and the paper guide, and a guide conveying unit to move the paper guide according to the detected state of the paper tray.

The foregoing and/or other aspects of the present general inventive concept may also be achieved by providing an image forming apparatus including a paper tray in which to load printing papers, and a paper-guiding device disposed at the paper tray to line up and hold the printing papers to match a width of the printing papers. The paper-guiding device includes at least one paper guide movably disposed at a paper tray to line up and hold the printing papers, a guide conveying unit to convey the at least one paper guide along the paper tray, and a position adjusting unit to control operations of the guide conveying unit, to detect a position of the at least one paper guide and to control a stop position of the at least one paper guide based on the detected position of the at least one paper guide.

The foregoing and/or other aspects of the present general inventive concept may also be achieved by providing an image forming apparatus, comprising a paper tray to support sheets of recording medium, a paper guide movable between a setting position disposed against edges of the sheets of recording medium and a waiting position disposed at an end of the paper tray opposite to the setting position, and a controller to move the paper guide to the setting position when the sheets of recording medium are disposed in the paper tray and to move the paper guide to the waiting position when the sheets of recording medium are exhausted.

The foregoing and/or other aspects of the present general inventive concept may also be achieved by providing a method of guiding printing papers in an image forming apparatus, including determining whether the printing papers are in a paper tray, determining a position of a paper guide, and adjusting the position of the paper guide according to the determined position of the paper guide and whether the printing papers are in the paper tray.

The determining of the paper guide may include determining of the position of the paper guide as one of a setting position in which the printing papers are lined up and held by the paper guide and a non-setting position in which the printing papers are not lined up and held by the paper guide.

The adjusting of the position of the paper guide may include conveying the paper guide to a first direction when the position of the paper guide is determined as the non-setting position, and when a predetermined time has not elapsed since the image forming apparatus has been turned on and although the position of the paper guide is determined as the setting position, detecting the position of the paper guide being in contact with the printing paper, and adjusting a stop position of the paper guide based on the detected position of the paper guide.

The adjusting of the stop position may include conveying the paper guide to the first direction by a predetermined distance “x” from the detected position of the paper guide, conveying the paper guide to a second direction by a distance that is more than two times the predetermined distance “x,” where the second direction is opposite to the first direction, conveying the paper guide to the first direction by the predetermined distance “x,” determining whether the paper guide comes in contact with the printing paper, and determining whether the paper guide is stopped according to whether the paper guide is in contact with the printing paper.

The predetermined distance “x” corresponds to allowable line up error of the printing paper and may be in a range of about 2 to 5 mm.

The determining of whether the paper guide is stopped may include stopping the paper guide when it is determined that the paper guide comes in contact with the printing paper.

The determining of the position of the paper guide may include determining the position of the paper guide as one of a waiting position in which the paper guide is in a position to await loading the printing papers in the paper tray and a non-waiting position in which the paper guide is not in the position to await the loading of the printing papers in the paper tray.

The adjusting of the position of the paper guide may include conveying the paper guide to a second direction when the position of the paper guide is determined as the non-waiting position, and detecting whether the paper guide reaches the waiting position, and stopping the paper guide when the paper guide reaches the waiting position.

The detecting of whether the paper guide reaches the waiting position may include detecting whether the paper guide reaches a stopper located at the waiting position.

The method may further include determining whether the printing papers are loaded in the paper tray, conveying the paper guide to a first direction opposite to the second direction when the printing paper is loaded in the paper tray, detecting the position of contacting the paper guide to the printing paper, and adjusting a stop position of the paper guide based on the detected position of the paper guide.

The foregoing and/or other aspects of the present general inventive concept may also be achieved by providing a method of an image forming apparatus having a paper tray to support sheets of recording medium, and a paper guide movable between a setting position disposed against edges of the sheets of recording medium and a waiting position disposed at an end of the paper tray opposite to the setting position, the method comprising sensing whether the sheets of recording medium are disposed in the paper tray, and automatically moving the paper guide to setting position when the sheets of recording medium are disposed in the paper tray and automatically moving the paper guide to the waiting position when the sheets of recording medium are exhausted.

The foregoing and/or other aspects of the present general inventive concept may also be achieved by providing an image forming apparatus, comprising a tray on which a recording medium is disposed, a guide unit disposed on the tray to guide the recording medium, and a unit to automatically move the guide unit according to a position of the guide unit, a size of the recording medium, and an existence of the recording medium.

### BRIEF DESCRIPTION OF THE DRAWINGS

These and/or other aspects of the present general inventive concept will be more apparent and more readily appreciated by describing embodiments of the present general inventive concept with reference to the accompanying drawings, in which:

FIG. 1 is a schematic perspective view illustrating a multifunctional apparatus having a conventional paper-guiding device;

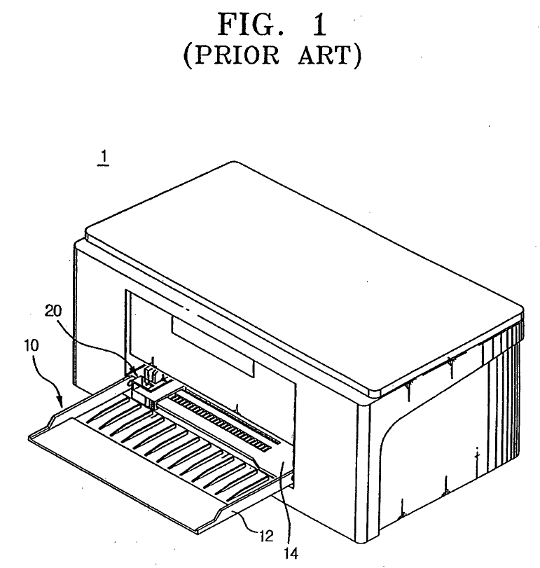

FIG. 2 is a perspective view illustrating the conventional paper-guiding device of the multifunctional apparatus of FIG. 1;

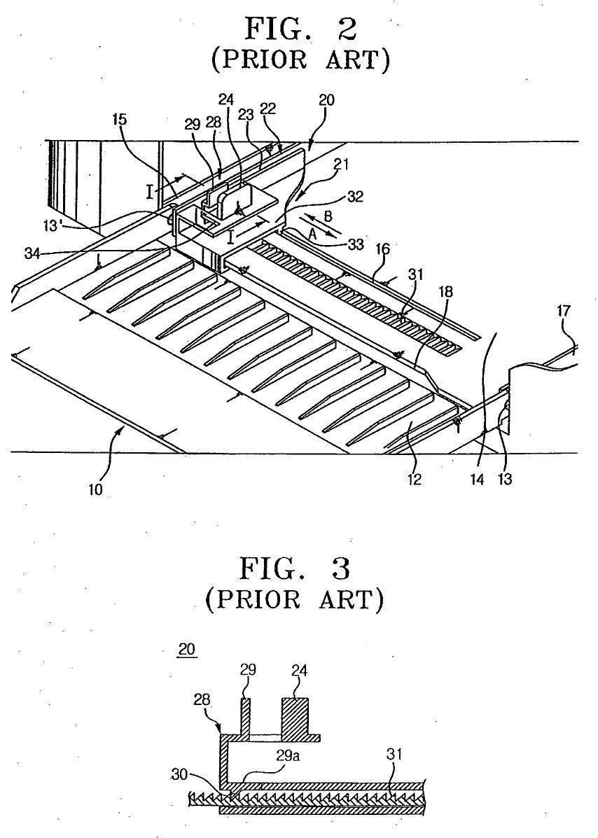

FIG. 3 is a cross-sectional view illustrating the conventional paper-guiding device of FIG. 2 along the line I-I′;

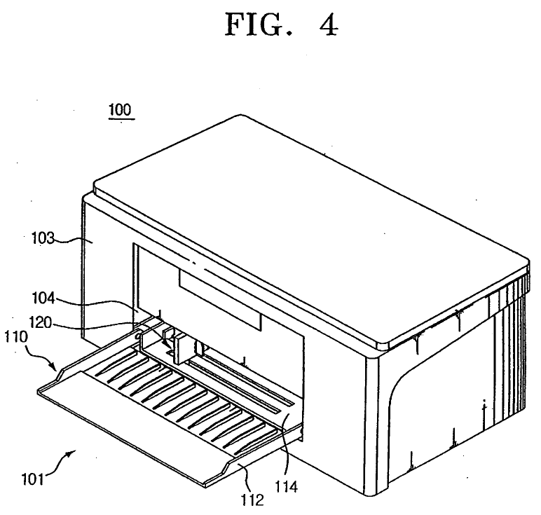

FIG. 4 is a schematic perspective view illustrating a multifunctional apparatus having a paper-guiding device according to an embodiment of the present general inventive concept;

FIG. 5 is a perspective view illustrating the paper-guiding device of the multifunctional apparatus of FIG. 4 according to an embodiment of the present general inventive concept;

FIG. 6 is a block diagram illustrating a controller of the paper-guiding device of FIG. 5 according to an embodiment of the present general inventive concept;

FIGS. 7A and 7B are cross-sectional views illustrating a paper detecting sensor of the paper-guiding device of FIG. 5 along the line II-II′ according to an embodiment of the present general inventive concept;

FIGS. 8A through 8C are front views illustrating a position detecting sensor of the paper-guiding device of FIG. 5 according to an embodiment of the present general inventive concept; and

FIG. 9 is a flowchart illustrating a method of guiding printing papers in a multifunctional apparatus having a paper-guiding device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

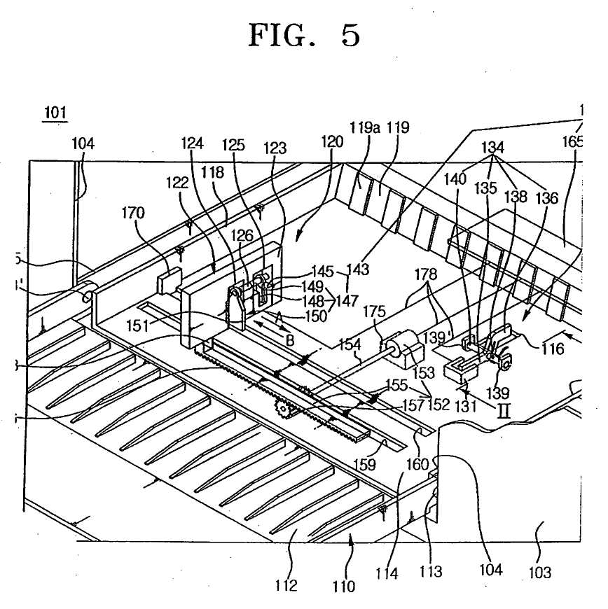

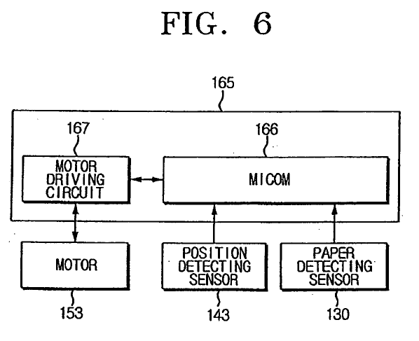

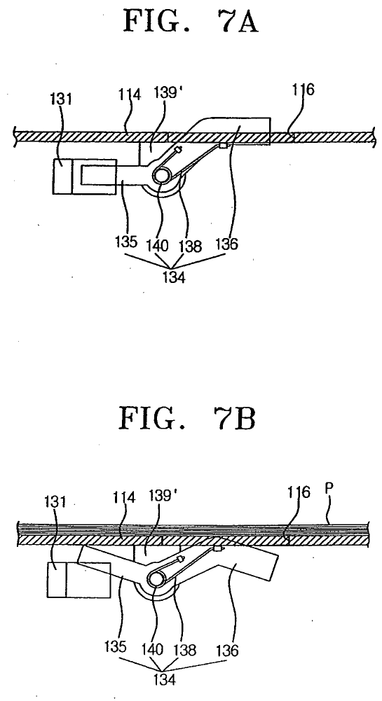

FIG. 4 is a schematic perspective view illustrating a multifunctional apparatus 100 having a paper-guiding device 120 according to an embodiment of the present general inventive concept, and FIG. 5 is a perspective view illustrating the paper-guiding device 120 of FIG. 4. The multifunctional apparatus 100 may be an image forming apparatus having functions of printing, copying, and scanning. Some of the components of the multifunctional apparatus 100 and the paper-guiding device 120 illustrated in FIGS. 4 and 5 will be described below with reference to FIGS. 6 to 8C.

Referring to FIGS. 4 and 5, the multifunctional apparatus 100 includes an outer case 103, a paper feeder 101 to feed printing papers P to a main body 104 disposed inside the outer case 103. The paper feeder 101 includes a paper cassette or a paper tray 110 in which to load a stack of printing papers P a paper-guiding device 120 to line up the loaded printing papers P and to hold the printing papers P in the lined up position (i.e., a proper position or a normal position) in the paper tray 110, and a pickup assembly (not shown) having a pickup roller (not shown) to pick up the printing papers P and to inwardly feed the printing papers P Although the embodiments of the present general inventive concept are described with reference to printing papers P, it should be understood that, more generally, sheets of a recording medium may be used with the present general inventive concept.

Detailed descriptions of the pickup assembly will not be provided here, because pickup assemblies should be known to those skilled in the art.

The paper tray 110 includes an outer holder 112 and an inner holder 114.

As illustrated in FIG. 5, the outer holder 112 is coupled to an inner frame 105 of the main body 104 through hinges 113 and 113′ disposed at both back-side ends of the outer holder 112 to open or to close an opening of the outer case 103.

The inner holder 114 is disposed on the inner frame 105 and includes an inclined wall 119, a first inner side wall 117 and a second inner side wall 118. A plurality of paper isolating members 119a are formed on the inclined wall 119 so that the pickup roller picks up the printing papers P loaded in the paper tray 110 one at a time. The plurality of paper isolating members 119a are separated with respect to each other by a predetermined distance as illustrated in FIG. 5. The first inner side wall 117 includes an inner surface 117a as a reference wall along which to line up and hold a first edge of the printing papers P loaded in the paper tray 110.

The paper-guiding device 120 includes a paper guide 122, a guide conveying unit 152, and a position adjusting unit 129.

The paper guide 122 is a rectangular plate having a guide surface 123 to line up (i.e., align) a second edge of the printing papers P and to hold the printing papers P in the lined up position. A coupling member 158 is formed at a bottom of the paper guide 122 to connect the paper guide 122 to one side end of a rack 155 in order to convey the paper guide 122 with the rack 155 of the guide conveying unit 152. The coupling member 158 is fixed to the rack 155 through a fixing member (not shown) such as a screw and the coupling member 158 is conveyed along a guide groove 159, which is formed in the inner holder 114 along a longitudinal direction of the inner holder 114, while the rack 155 is conveyed.

The guide conveying unit 152 conveys the paper guide 122 in a right direction A or a left direction B as illustrated in FIG. 5: The guide conveying unit 152 includes a motor 153, a pinion 157, and the rack 155.

The motor 153 is fixed and supported by a fixing bracket 175 formed in the inner frame 105.

The pinion 157 is disposed at one end of a driving shaft 154 of the motor 153.

The rack 155 is connected to the coupling member 158 formed at the bottom of the paper guide 122 in order to convey the paper guide 122. A rack gear 156 is formed on a bottom surface of the rack 155 and the rack gear 156 is geared with the pinion 157. Accordingly, when the pinion 157 is rotated by the driving shaft 154 of the motor 153, the rack 155 is shifted in the right direction A or the left direction B and the paper guide 122 is also conveyed with the rack 155 in the corresponding directions.

The position adjusting unit 129 controls operations of the guide conveying unit 152, detects a position of the paper guide 122 while conveying the paper guide 122 and adjusts a stop position of the paper guide 122 based on the detected position of the paper guide 122. The position adjusting unit 129 includes a paper detecting sensor 130, a position detecting sensor 143, and a controller 165.

The paper detecting sensor 130 determines whether the printing papers P are loaded in the paper tray 110 or not. The paper detecting sensor 130 may be disposed at a right side of the inner holder 114 of the paper tray 110.

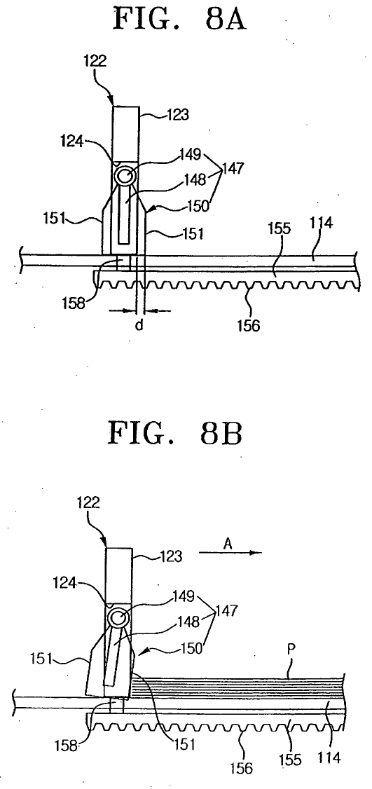

FIGS. 7A and 7B are cross-sectional views illustrating the paper detecting sensor 130 of the paper-guiding device 120 of FIG. 5 along the line II-II′ according to an embodiment of the present general inventive concept. As illustrated in FIGS. 7A and 7B, the paper detecting sensor 130 of FIG. 5 may be a photo sensor having a first sensing unit 131 and a first sensing actuator 134.

The first sensing unit 131 includes a first light-emitting unit (not shown) and a first light-receiving unit (not shown) which are disposed a predetermined distance apart.

As illustrated in FIG. 7A, the first sensing actuator 134 includes a first operating end 136, a first sensing end 135, a first support rod 140, and a spring 138. The first operating end 136 projects upwardly through an opening 116 formed in the inner holder 114. The first sensing end 135 is formed as a bar shape and is interposed between the first light-emitting unit and the first light-receiving unit. Referring to FIG. 5, the first sensing end 135 blocks or opens a light path between the first light-emitting unit and the first light-receiving unit of the first sensing unit 131 in order to drive the first sensing unit 131. Referring to FIGS. 5 and 7A, the first support rod 140 is supported by brackets 139 and 139′ fixed at a bottom surface of the inner holder 114. The spring 138 is disposed at the first support rod 140. That is, the spring 138 is wound around the first support rod 140 . One end of the spring 138 is fixed at a mounting member formed on the bottom surface of the inner holder 114 and the other end of the spring 138 is fixed at another mounting member formed on the first operating end 136 of the first sensing actuator 134. Accordingly, the first operating end 136 is projected upwardly through the opening 116 of the inner holder 114 by an elastic force of the spring 138.

As illustrated in FIG. 7B, the first operating end 136 is pushed downwardly through the opening 116 of the inner holder 114 by a weight of printing paper P when the printing paper P is loaded in the paper tray 110. As a result, the first operating end 136 is rotated about the first support rod 140 in a clockwise direction. Accordingly, the first sensing end 135 connected to the first operating end 136 is shifted from a blocking position to an opening position to open the light path between the first light-emitting unit and the first light-receiving unit. The blocking position represents a position in which the light path between the first light-emitting unit and the first light-receiving unit is blocked by the first sensing end 135. When the light path is not blocked by the first sensing end 135 (i.e., in the opening position), the first sensing unit 131 generates a first ON-signal, i.e., a high signal, which indicates that the printing paper P is loaded in the paper tray 110.

On the other hand, the first operating end 136 projects upwardly through the opening 116 of the inner holder 114 by the elastic force of the spring 138 when the printing papers P in the paper tray 110 are completely exhausted (i.e., when there is no printing paper P on the paper tray 110). As a result, the first operating end 136 is rotated about the first support rod 140 in a counter clockwise direction. Therefore, the first sensing end 135 returns from the opening position to the blocking position, and the first sensing unit 131 generates a first OFF-signal, i.e., a low signal, which indicates that the printing paper P is not loaded in the paper tray 110.

Referring back to FIG. 5, the position detecting sensor 143 is disposed at the paper guide 122 to detect the position of the paper guide 122.

The position detecting sensor 143 may be a photo sensor having a second sensing unit 145 and a second sensing actuator 147.

The second sensing unit 145 is disposed at a first installation opening 125 formed on a rear surface of the paper guide 122 and includes a second light-emitting unit (not shown) and a second light-receiving unit (not shown).

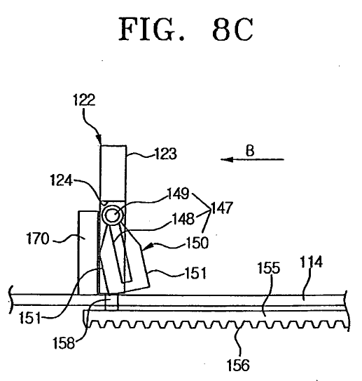

FIGS. 8A through 8C are front views illustrating the position detecting sensor 143 of the paper-guiding device 120 of FIG. 5 according to an embodiment of the present general inventive concept. Referring to FIGS. 5 and 8A to 8C, the second sensing actuator 147 includes a second sensing end 148, a second operating end 150, and a second support rod 149. The second sensing end 148 is formed as a bar shape and is interposed between the second light-emitting unit and the second light-receiving unit of the second sensing unit 145 of FIG. 5. The second sensing end 148 blocks or opens a light path between the second light-emitting unit and the second light-receiving unit of the second sensing unit 145 when in a blocking position or an opening position, respectively. The second operating end 150 is formed as a plate member of a pentagon shape which is disposed at a second installation opening 124 at a center of the paper guide 122. An operating guide groove 160 (see FIG. 5) may be formed in the inner holder 114 along a convey path of the second operating end 150 along a length of the inner holder 114 so that the second operating end 150 is freely operated (i.e., movable about the second support rod 149 and along the operating guide groove 160) while the paper guide 122 is conveyed in the left direction B or the right direction A. As illustrated in FIG. 8A, both end surfaces 151 of the second operating end 150 are formed as a vertical surface to easily contact the printing paper P or a stopper 170 (see FIGS. 5, 8B, and 8C). Also, the end surfaces 151 of the second operating end 150 project outwardly from the paper guide 122 by a first predetermined distance “d.” While adjusting the stop position of the paper guide 122, the printing paper P is shifted by a second predetermined distance “x,” and then the printing paper P returns to an original position without being disturbed by the end surfaces 151 of the second operating end 150. Accordingly, the first predetermined distance “d” is set to be shorter than the second predetermined distance “x” so that the second sensing end 148 is positioned at the blocking position between the second light-emitting unit and the second light-receiving unit of the second sensing unit 145. For example, the first predetermined distance “d” can be set in a range of 0.5 to 1.5 mm. The second support rod 149 is rotatably disposed at a fixing hole 126 (see FIG. 5) formed between the first installation opening 125 and the second installation opening 124 in the paper guide 122. Also, the second support rod 149 fixes and connects the second sensing end 148 and the second operating end 150.

As illustrated in FIG. 8A, the second operating end 150 is positioned at a vertical position where the second operating end 150 is not rotated in any direction when the paper guide 122 is at a non-setting position or at a non-waiting position. Herein, the non-setting position represents a position of the paper guide 122 when the paper guide 122 does not contact the printing paper P or when the paper guide 122 does not line up or hold the printing paper P The non-waiting position represents a position of the paper guide 122 in which the paper guide 122 is not waiting for loading of the printing paper P, i.e., when the paper guide 122 does not come in contact with the stopper 170. Accordingly, the second sensing end 148 is positioned at the blocking position between the second light-emitting unit and the second light-receiving unit of the second sensing unit 145, and the second sensing unit 145 generates a second OFF-signal, i.e., a low signal, which indicates that the paper guide 122 is at the non-setting position or the non-waiting position.

As illustrated in FIG. 8B, the second operating end 150 is pushed by the printing paper P to be rotated in the clockwise direction when the paper guide 122 is shifted by the rack 155 to the right direction A to a contacting position where the printing paper P contacts with the paper guide 122 or a setting position in which the paper guide 122 lines up and holds the printing paper P. As a result, the second sensing end 148 is shifted from the blocking position to the opening position to open the light path between the second light-emitting unit and the second light-receiving unit, and the second sensing unit 145 generates a second ON-signal, i.e., a high signal, which indicates that the paper guide 122 is at the contacting position or the setting position.

As illustrated in FIG. 8C, the second operating end 150 is rotated to the counter clockwise direction by the stopper 170 when the paper guide 122 is shifted to the left direction B by the rack 155 of the guide conveying unit 152 and reaches the waiting position in which the paper guide 122 contacts the stopper 170. As a result, the second sensing end 148 is shifted from the blocking position to the opening position, and the second sensing unit 145 generates the second ON-signal, i.e., the high signal, which indicates that the paper guide 122 is at the waiting position.

FIG. 6 is a block diagram illustrating the controller 165 of the paper-guiding device 120 of FIG. 5 according to an embodiment of the present general inventive concept. As illustrated in FIGS. 5 and 6, the controller 165 is disposed at the inner frame 105 at, for example, the rear of the inner holder 114. The controller 165 may be a printed circuit board integrated with a MICOM 166 (e.g., a microcomputer) to generally control overall operations of the multifunctional apparatus 100 and a motor driving circuit 167 to control the motor 153.

The MICOM 166 and the motor driving circuit 167 are connected to the paper detecting sensor 130, to the position detecting sensor 143, and to the motor 153, respectively, through a connecting line 178. The connecting line 178 may include a plurality of connecting lines 178.

Referring to FIGS. 5 and 6, the controller 165 controls the guide conveying unit 152 to convey the paper guide 122 to the setting position according to the position of the paper guide 122 when the printing paper P is loaded in the paper tray 110.

That is, the MICOM 166 of the controller 165 generates and outputs a control signal to the motor driving circuit 167 to convey the paper guide 122 in the right direction A to contact the printing paper P when the printing paper P is loaded in the paper tray 110 and the paper guide 122 is at the non-setting position. In other words, when the first sensing unit 131 of the paper detecting sensor 130 generates the high signal (i.e., the first ON-signal) and the second sensing unit 145 of the position detecting sensor 143 generates the low signal (i.e., the second OFF-signal) the MICOM 166 controls the paper guide 122 to move in the right direction and to contact the printing papers P. Also, the MICOM 166 of the controller 165 generates and outputs a control signal to the motor driving circuit 167 to control the stop position of the paper guide 122 according to the high signal generated from the second sensing unit 145 of the position detecting sensor 143. In other words, the paper guide 122 is stopped when the paper guide 122 makes contact with the printing papers P.

The MICOM 166 determines that the paper guide 122 is at the setting position when the printing paper P is loaded in the paper tray 110 and when the paper guide 122 is at the setting position, that is, when the first sensing unit 131 of the paper detecting sensor 130 generates the high signal (i.e., the first ON-signal) and when the second sensing unit 145 of the position detecting sensor 143 generates the high signal (i.e., the second ON-signal). Then, the MICOM 166 generates and outputs a control signal to the motor driving circuit 167 to hold a current position of the paper guide 122.

However, the MICOM 166 generates and outputs a control signal to the motor driving circuit 167 to convey the paper guide 122 in the right direction A if a predetermined time (e.g., 5 seconds) has not elapsed since the multifunctional apparatus 100 is turned on although the first sensing unit 131 of the paper detecting sensor 130 generates the high signal and the second sensing unit 145 of the position detecting sensor 143 generates the high signal. In other words, the MICOM 166 controls the paper guide 122 to move when the multifunctional apparatus 100 is initialized even though the sensing units 131 and 145 indicate that the paper guide 122 is in the setting position. Then, the MICOM 166 generates and outputs a control signal to adjust the stop position of the paper guide 122 to the motor driving circuit 167 to control operation of the motor 153 when the paper guide 122 reaches the contacting position and thereby the second sensing unit 145 of the position detecting sensor 143 generates the high signal. That is, the MICOM 166 may control the paper guide 122 to stop in response to the high signal generated by the second sensing unit 145. A description of the reasons for performing the operation is as follows. The paper guide 122 is at the setting position when both of the first sensing unit 131 and the second sensing unit 145 generate the high signals. Accordingly, the paper guide 122 is not required to be moved again to the setting position. However, the lining up of the printing papers P may be changed due to a manual shifting of the paper guide 122 by a user while the multifunctional apparatus 100 is turned off. For example, the manual shift of the paper guide 122 may be intentional or accidental. Accordingly, the position of the paper guide 122 may be adjusted when the multifunctional apparatus 100 is initially turned on to compensate for any manual shift that occurs when the multifunctional apparatus 100 is off. This compensation is performed by repeatedly adjusting the position of the paper guide 122 in the right direction A and the left direction B.

The adjusting of the stop position of the paper guide 122 by the MICOM 166 may be achieved as follows. When the paper guide 122 reaches the contacting position and thereby the second sensing unit 145 of the position detecting sensor 143 generates the high signal, the paper guide 122 is conveyed to the right direction A by the second predetermined distance “x,” and then, the paper guide 122 is conveyed to the left direction B by two times the second predetermined distance “x.” Then, the paper guide 122 is conveyed to the right direction A by the second predetermined distance “x.” If the second sensing unit 145 regenerates the high signal (indicating that the paper guide 122 is in the contacting position), the motor 153 is controlled to stop the paper guide 122. Herein, if the second sensing unit 145 generates the low signal (indicating that the paper guide 122 is in a non-contacting position), the paper guide 122 is conveyed to the right direction A until the high signal is generated. Then, the adjusting operation of the stop position of the paper guide 122 is repeatedly performed. Therefore, the second predetermined distance “x” can be set within a range of allowable line-up errors between the printing paper P and the inner surface 117a of the first inner surface wall 117 or between the printing paper P and the guide surface 123 of the paper guide 122. For example, the second predetermined distance “x” may be set in a range of 2 to 5 mm.

As described above, the paper guide 122 is conveyed to the printing paper P by a little more than the allowable line-up error, and then is conveyed in the opposite direction in order to return the paper guide 122 to an initial position. Once the paper guide 122 is returned to the initial position, it determines whether the paper guide 122 is stopped or conveyed according to whether the position detecting sensor 143 is operated by the printing paper P or not. These operations will be described hereinafter.

If the printing papers P are lined up between the guide surface 123 and the inner side wall 117a based on an operating range of the second operating end 150 that projects from the guide surface 123 where the operating range is a first gap that is narrower than the first predetermined distance “d” (i.e., 0.5 to 1.5 mm), the printing paper P is bent by a difference between the first gap and the second predetermined distance “x” when the guide surface 123 pushes the printing paper P by the second predetermined distance “x” (i.e., 2 to 5 mm) to adjust the stop position of the paper guide 122. Then, if the guide surface 123 returns to the initial position after being shifted to the left direction B and the right direction A, the printing paper P is unrolled and lined up being separated from the guide surface 123 by the first gap. Herein, the second operating end 150 is pushed by the printing paper P as illustrated in FIG. 8B, since the second operating end 150 projects from the guide surface 123 by the first predetermined distance “d,” which is longer than the first gap. As a result, the second sensing end 148 is positioned at the opening position to open the light path between the second light-emitting unit and the second the light-receiving unit of the second sensing unit 145. Accordingly, the second sensing unit 145 generates the high signal.

On the other hand, if the printing papers P are lined up between the guide surface 123 and the inner side wall 117a with a second gap that is wider than the first predetermined distance “d,” the printing paper P is bent by a difference between the second gap and the second predetermined distance “x” or is pushed by the second predetermined distance “x” when the guide surface 123 pushes the printing paper P by the second predetermined distance “x.” Then, if the guide surface 123 is shifted to the left direction B and the right direction A and then returns to the initial position, the printing papers P are lined up separated from the guide surface 123 by the second gap. Herein, as illustrated in FIG. 8A, the operating end 150 is at the vertical position without being disturbed by the printing paper P because the operating end 150 projects from the guide surface 123 by the first predetermined distance “d” which is shorter than the second gap. As a result, the second sensing end 148 is positioned at the blocking position to block the light path between the second light-emitting unit and the second light-receiving unit of the second sensing unit 145. Accordingly, the second sensing unit 145 generates the low signal.

As described above, if the second sensing unit 145 generates the high signal when the paper guide 122 is returned to the initial position, the second sensing unit 145 determines that the printing paper P is in a normal position (i.e., the setting position) in which the printing papers P are lined up with a gap (e.g., the first gap) that is shorter than the first predetermined distance “d.” On the other hand, if the second sensing unit 145 generates the low signal, the second sensing unit 145 determines that the printing paper P is not in the normal position (i.e., the setting position) in which the printing papers P are lined up with a gap (e.g., the second gap) that is longer than the first predetermined distance “d.”

Accordingly, if the second sensing unit 145 generates the low signal, the MICOM 166 controls the motor 153 through the motor driving circuit 167 to convey the paper guide 122 to the right direction A and to adjust the stop position of the paper guide 122 repeatedly until the second sensing unit 145 generates the high signal to indicate that the paper guide 122 has reached the contacting position that corresponds to the setting position.

The controller 165 controls the guide conveying unit 152 to convey the paper guide 122 to the waiting position as illustrated in FIG. 8C to await the loading of the printing paper P. when the printing paper P is not loaded in the paper tray 110.

More specifically, the MICOM 166 of the controller 165 outputs the control signal to the motor driving circuit 167 to control the motor 153 of the guide conveying unit 152 to convey the paper guide 122 to the waiting position, when the printing paper P is determined not to be in the paper tray 110 and when the paper guide 122 is determined not to be at the waiting position. In other words, the MICOM 166 of the controller 165 outputs the control signal to the motor driving circuit 167 to control the motor 153 of the guide conveying unit 152 to convey the paper guide 122 to the waiting position, when the first sensing unit 131 of the paper detecting sensor 130 generates the low signal and when the second sensing unit 145 of the position detecting sensor 143 generates the low signal. Also, the MICOM 166 outputs a control signal to the motor driving circuit 167 to control the motor 153 to stop conveying of the paper guide 122 according to the high signal generated by the second sensing unit 145 of the position detecting sensor 143, when the paper guide 122 reaches the waiting position adjacent to the stopper 170.

The paper guiding device 120 further includes the stopper 170 to restrict the paper guide 122 from being shifted passed the waiting position and to operate the position detecting sensor 143 at the same time.

The stopper 170 is disposed in a rotation path of the second operating end 150 of the position detecting sensor 143 around the second side wall 118 of the inner holder 114. As illustrated in FIG. 8C, the stopper 170 stops the paper guide 122 to restrict the paper guide 122 from being shifted passed the waiting position when the paper guide 122 reaches the waiting position, and rotates the second operating end 150 in the counter clockwise direction. Accordingly, the second sensing end 148 is shifted from the blocking position to the opening position, and the second sensing unit 145 generates the high signal to indicate that the paper guide 122 has reached the waiting position.

Also, the MICOM 166 generates and outputs a control signal to the motor driving circuit 167 to control the motor 153 to hold the current position of the paper guide 122 when the printing paper P is not in the paper tray 100 and when the paper guide 122 is at the waiting position (i.e., when the first sensing unit 131 of the paper detecting sensor 130 generates the low signal and when the second sensing unit 145 of the position detecting sensor 143 generates the high signal). Once the first sensing unit 131 generates the high signal to indicate that the paper has been recently loaded, the MICOM 166 begins moving the paper guide 122 to the setting position.

In the present embodiment, the multifunctional apparatus 100 is illustrated by way of example of an image forming apparatus and includes the paper-guiding device 120 according to the embodiments of the present general inventive concept. However, the present general inventive concept is not limited to the multifunctional apparatus 100, and it should be understood that the paper-guiding device 120 can be implemented in other image forming apparatuses such as an inkjet printer, or a laser printer.

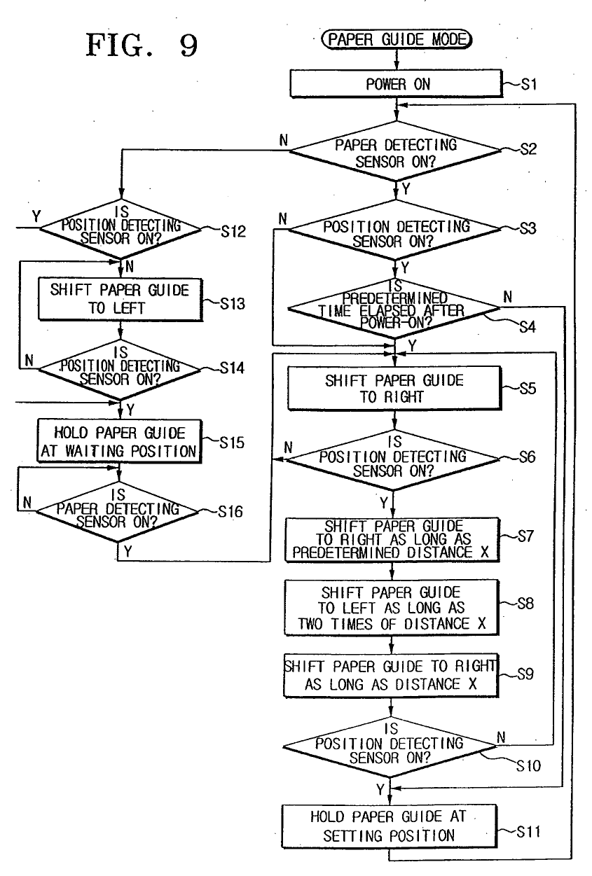

Hereinafter, a method of guiding printing papers in the multifunctional apparatus 100 having the paper-guiding device 120 will be described with reference to FIG. 9 along with the previous FIGS.

Referring to FIG. 9, when the multifunctional apparatus 100 is turned on in operation S1, the MICOM 166 of the controller 165 determines whether the printing paper P is loaded in the paper tray 110 or not according to signals output from the paper detecting sensor 130 using the determination process described with reference to FIGS. 7A and 7B in operation S2.

In the operation S2, if the paper detecting sensor 130 outputs the high signal (i.e., the first ON-signal), the MICOM 166 determines that the printing papers P is loaded in the paper tray 110. If the paper detecting sensor 130 outputs the low signal (i.e., the first OFF-signal), the MICOM 166 determines that printing paper P is not loaded in the paper tray 110.

If the MICOM 166 determines that the printing paper P is loaded in the paper tray 110 in the operation S2, the MICOM 166 determines whether the paper guide 122 is at the setting position to line up and hold the printing paper P or the non-setting position not to line up and hold the printing paper P according to the output signal from the position detecting sensor 143 using the determination process described with reference to FIGS. 8A and 8B in operation S3.

In the operation S3, the MICOM 166 determines that the paper guide 122 is at the setting position if the position detecting sensor 143 outputs the high signal (i.e., the second ON-signal), and the MICOM 166 determines that the paper guide 122 is at the non-setting position if the position detecting sensor 143 outputs the low signal (i.e., the second OFF-signal).

As a result of the determination in the operation S3, if the paper guide 122 is in the setting position, the MICOM 166 determines whether a predetermined time (e.g., 5 seconds) has elapsed since the multifunctional apparatus 100 has been turned on in operation S4. If the paper guide 122 is at the non-setting position, operation S5 is performed.

As a result of the determination in the operation S4, the MICOM 166 determines that operations S5 through S10 have already been performed to control changes of lining up (i.e., an alignment) of the printing paper P that may occur when the multifunctional apparatus 100 is turned off, if the predetermined time has passed since the multifunctional apparatus 100 is turned on and moves to operation S11. In otherwords, the MICOM 166 performs an initialization procedure to move the paper guide 122 to the setting position and if the predetermined time has passed since the multifunctional apparatus 100 was turned on, the MICOM 166 determines that the initialization procedure has already been performed. The initialization procedure ensures that the printing papers P are positioned against the inner surface 117a of the first inner sidewall.

As a result of the determination in the operation S4, if less than the predetermined time has passed since the multifunctional apparatus 100 is turned on, the MICOM 166 performs operations to control lining up (i.e., the alignment) of the printing paper P which is changed while the multifunction apparatus 100 is turned off. That is, the MICOM 166 controls the motor 153 of the guide conveying unit 152 through the motor driving circuit 167 to convey the paper guide 122 to the right direction A to reach the second edge of the printing paper P in operation S5. Herein, since the driving force of the motor 153 is transferred to the rack 155 through the driving shaft 154, the pinion 157 and the rack gear 156, the paper guide 122 connected to the rack 155 through the coupling member 158 is conveyed to the right direction A.

When the paper guide 122 reaches at the second edge of the printing paper P, the printing paper P pushes the second operating end 150 of the position detecting sensor 143 and then the second operating end 150 is rotated in the clockwise direction. As a result, the second sensing end 148 is shifted from the blocking position to the opening position between the second light-emitting unit and the second light-receiving unit of the second sensing unit 145. Accordingly, the second sensing unit 145 generates the high signal (i.e., the second ON-signal).

When the high signal is output by the second sensing unit 145, the MICOM 166 determines that the guide surface 123 of the paper guide 122 is at the contacting position that indicates a position where the guide surface 123 is in contact with the second edge of the printing paper P in operation S6. The MICOM 166 then controls the motor 153 through the motor driving circuit 167 to convey the paper guide 122 to a first direction a little more, for example, to the right direction A by 2 to 5 mm that corresponds to the second predetermined distance “x,” and then stops the motor 153 in operation S7. Herein, if the printing papers P are lined up between the guide surface 123 and the first inner side wall 117a of the first side wall 117 without any gap, the printing papers P are bent since the guide surface 123 pushes the printing paper R The printing papers P can then be flattened when the guide surface 123 is shifted to the left direction B.

The MICOM 166 controls the motor 153 through the motor driving circuit 167 to a second direction, for example, to the left direction B, in operation S8. That is, the MICOM 166 controls the motor 153 to convey the guide surface 123 of the paper guide 122 to the left direction B by a distance that is longer than two times the second predetermined distance “x” in the operation S8. For example, the paper guide 122 may be conveyed to the left direction B by about 4 to 10 mm, and the MICOM 166 can then stop the motor 153 in operation S8.

The MICOM 166 again controls the motor 153 through the motor driving circuit 167 to the first direction. That is, the MICOM 166 controls the motor 153 to convey the guide surface 123 of the paper guide 122 to the right direction A by the second predetermined distance “x,” for example, 2 to 5 mm, and then stops the motor 153 in operation S9. Herein, the paper guide 122 is positioned at the contacting position in which the paper guide 122 contacts the second edge of the printing paper P without applying any force thereto. In other words, the paper guide 122 is positioned where the second sensing unit 145 begins to generate the high signal (i.e., where the guide surface 123 barely touches the second edge of the printing paper P).

In this configuration, the MICOM 166 determines whether the guide surface 123 is at the contacting position where the paper guide 122 is in contact with the second edge of the printing paper P (i.e., whether the second sensing unit 145 of the position detecting sensor 143 outputs the high signal) in operation S10.

As a result of the determination in the operation S10, if the second sensing unit 145 outputs the high signal, the MICOM 166 determines that the printing papers P are perfectly lined up within a range that corresponds to the normal position (i.e., the setting position) and holds the paper guide 122 at the setting position in operation S11. In the setting position, a distance from the second edge of the printing paper P to the guide surface 123 is controlled to be less than the first predetermined distance “d” which is a distance by which the second operating end 150 projects from the guide surface 123. That is, the distance is controlled to be shorter than about 0.5 to 1.5 mm which is a distance of operating the second sensing unit 145 by the second operating end 150 pushed by the printing paper P.

As a result of the determination in the operation S10, if the second sensing unit 145 outputs the low signal (i.e., the second OFF-signal), the MICOM 166 determines that the printing papers P are not perfectly lined up and repeatedly performs the operations S5 through S9.

Referring back to the operation S2, if the printing paper P is determined not to be in the paper tray 110, the MICOM 166 determines whether the paper guide 122 is at the waiting position to await the loading of the printing paper P, or the non-waiting position not to await the loading of the printing paper P according to the signal output from the position detecting sensor 143 using the determination process described with reference to FIGS. 8A through 8C in operation S12.

That is, the MICOM 166 determines that the paper guide 122 is at the waiting position if the position detecting sensor 143 outputs the high signal (i.e., the second ON-signal), and the MICOM 166 determines that the paper guide 122 is at the non-waiting position if the position detecting sensor 143 outputs the low signal (i.e., the second OFF-signal).

As a result of the determination in the operation S12, if the paper guide 122 is at the waiting position, the MICOM 166 performs an operation S15. However, if the paper guide 122 is at the non-waiting position, the MICOM 166 controls the motor 153 through the motor driving circuit 167 to shift the paper guide 122 to the left direction B through the driving shaft 154, the pinion 157, and the rack 155 in order to shift the paper guide 122 to the waiting position in operation S13.

Once the paper guide 122 reaches the waiting position as illustrated in FIG. 8C, the second operating end 150 of the position detecting sensor 143 contacts the stopper 170 and is rotated in the counter clockwise direction. As a result, the second sensing end 148 is shifted from the blocking position to the opening position and the second sensing unit 145 generates the high signal (i.e., the second ON-signal).

When the second sensing unit 145 generates the high signal, the MICOM 166 determines that the guide surface 123 of that paper guide 122 is at the waiting position where the stopper 170 is contacted in operation S14, controls the motor 153 to be stopped by the motor driving circuit 167 and holds the current position of the paper guide 122( i.e., the waiting position) in operation S15.

The MICOM 166 can then repeatedly determine whether the printing paper P is in the paper tray 110 similarly to the operation S2 to convey the paper guide 122 to the setting position when the printing paper P is loaded in the paper tray 110 in operation S16.

As a result of the determination in the operation S16, if the printing paper P is determined to be in the paper tray 110, the MICOM 166 performs the operation S5 and following operations in order to shift the paper guide 122 to the setting position.

As described above, an image forming apparatus having a paper guiding device and the method thereof according to the various embodiments of the present general inventive concept automatically lines up and holds printing papers in a paper tray. Therefore, the image forming apparatus can conveniently load and line up the printing papers without manual operations. Also, a degradation of printing quality caused by inaccuracy of a manual loading operation and a manual lining up operation can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A paper-guiding device usable in an image forming apparatus, the device comprising:
at least one paper guide movably disposed at a paper tray to line up and hold at least one printing paper on the paper tray;
a guide conveying unit to convey the at least one paper guide along the paper tray; and
a position adjusting unit to control operations of the guide conveying unit, to detect a position of the at least one paper guide, and to control a stop position of the at least one paper guide based on the detected position of the at least one paper guide.

2. The paper-guiding device of claim 1, wherein the guide conveying unit comprises:
a motor;
a pinion disposed at a driving shaft of the motor; and
a rack connected to the at least one paper guide to transfer a rotation force of the pinion to the at least one paper guide and being geared on the pinion.

3. The paper-guiding device of claim 1, wherein the position adjusting unit comprises:
a paper detecting sensor to detect whether the printing paper is loaded in the paper tray;
a position detecting sensor disposed at the at least one paper guide to be operated by the printing paper according to a movement of the at least one paper guide to detect the position of the at least one paper guide; and
a controller to control the guide conveying unit to convey the at least one paper guide according to signals output from the paper detecting sensor and the position detecting sensor, and to control the guide conveying unit to control the stop position of the at least one paper guide according to the signals output from the position detecting sensor while the at least one paper guide is being conveyed.

4. The paper-guiding device of claim 3, wherein the paper detecting sensor comprises a photo sensor.

5. The paper-guiding device of claim 3, wherein the position detecting sensor comprises a photo sensor.

6. The paper-guiding device of claim 5, wherein the position detecting sensor comprises:
a sensing unit disposed at the at least one paper guide and having a light-emitting unit and a light-receiving unit; and
an actuator having a sensing end movably disposed between the light-emitting unit and the light-receiving unit, an operating end having at least one end surface projecting from the at least one paper guide by a first predetermined distance, and a support rod connecting the sensing end and the operating end to be rotatable together.

7. The paper-guiding device of claim 6, wherein the operating end is formed as a pentagon shape.

8. The paper-guiding device of claim 6, wherein the first predetermined distance is in a range of about 0.5 to 1.5 mm.

9. The paper-guiding device of claim 3, wherein the controller controls the guide conveying unit to convey the at least one paper guide to a first direction to contact the printing paper when the paper detecting sensor outputs a first ON-signal and the position detecting sensor outputs a second OFF-signal, and controls the guide conveying unit to adjust the stop position of the at least one paper guide when the at least one paper guide comes in contact with the printing paper to cause the position detecting sensor to generate a second ON-signal.

10. The paper-guiding device of claim 9, wherein if a predetermined time has not elapsed since the image forming apparatus is turned on when the paper detecting sensor generates the first ON-signal and the position detecting sensor outputs the second ON-signal, the controller controls the guide conveying unit to convey the at least one paper guide to the first direction and controls the guide conveying unit to adjust the stop position of the at least one paper guide when the at least one paper guide comes in contact with the printing paper to cause the position detecting sensor to output the second ON-signal.

11. The paper-guiding device of claim 9, wherein the stop position of the at least one paper guide is determined according to whether the position detecting sensor generates the second ON-signal again after when the at least one paper guide comes in contact with the printing paper to cause the position detecting sensor to output the second ON-signal, the at least one paper guide is shifted to the first direction by a second predetermined distance shifted to a second direction which is opposite to the first direction by about two times the second predetermined distance, and then shifted to the first direction again by about the second predetermined distance.

12. The paper-guiding device of claim 11, wherein the second predetermined distance corresponds to an allowable line up error of the printing paper.

13. The paper-guiding device of claim 12, wherein the second predetermined distance is in a range of about 2 to 5 mm.

14. The paper-guiding device of claim 9, further comprising:
at least one stopper disposed at the paper tray to restrict the at least one paper guide from being shifted passed a waiting position when the at least one paper guide reaches the waiting position which is a position in which the at least one paper guide awaits loading of printing papers to the paper tray, and to operate the position detecting sensor at the same time, and
the controller controls the guide conveying unit to shift the at least one paper guide to the second direction where the at least one paper guide contacts the stopper when the paper detecting sensor outputs the first OFF signal and the position detecting sensor outputs the second OFF signal, and controls the guide conveying unit to stop the at least one paper guide when the at least one paper guide comes in contact with the stopper to cause the position detecting sensor to output the second ON signal.

15. A paper guiding device usable with an image forming apparatus, the device comprising:
a paper tray;
a paper guide movable along the paper tray to hold a recording medium in a predetermined position;
a sensing unit to detect a state of the paper tray and the paper guide; and
a guide conveying unit to move the paper guide according to the detected state of the paper tray and the paper guide.

16. The device of claim 15, wherein the sensing unit comprises:
a medium detecting sensor to detect whether the recording medium is disposed in the paper tray;
a position detecting sensor to detect a position of the paper guide; and
a controller to control the guide conveying unit to move the paper guide to a setting position to hold the recording medium in the predetermined position when the recording medium is disposed in the paper tray.

17. The device of claim 16, wherein the controller further moves the paper guide to a waiting position when the recording medium is not disposed in the paper tray.

18. The device of claim 16, wherein the medium detecting sensor comprises:
a movable operating end disposed in the paper tray to be moved below the paper tray by the recording medium when the recording medium are disposed in the paper tray; and
a sensing end opposite to the operating end to open and block a sensing unit according to the movement of the operating end.

19. The of claim 16, wherein:
the paper guide comprises a flat surface to engage a first edge of the recording medium; and
the position detecting sensor comprises
an opening in the flat surface of the paper guide having a movable operating end extending therethrough and on both sides such that when the flat surface engages the first edges of the recording medium or an end of the paper tray, the operating end is pushed through the opening, and
a sensing end coupled to the operating end through a support rod to open and block a sensing unit according to the movement of the operating end.

20. The device of claim 15, further comprising:
a controller to control the guide conveying unit to perform an initialization procedure when the image forming apparatus is powered on such that the guide conveying unit repeatedly moves the paper guide back and forth against the recording medium such that the recording medium are aligned between an end of the paper tray and the paper guide.

21. The device of claim 15, wherein:
the paper tray includes a first end where the recording medium are to be disposed and a second end opposite the first end; and
the sensing unit provides a first ON signal when the recording medium are disposed in the paper tray, provides a first OFF signal when the recording medium are not disposed in the paper tray, provides a second ON signal when the paper guide is disposed at the second end of the paper tray or when the paper guide is disposed at the first end of the paper tray and the recording medium are disposed in the paper tray, and provides a second OFF signal when the paper guide is disposed at neither one of the first and second ends or when the paper guide is disposed at the first end and the recording medium are not disposed in the paper tray.

22. An image forming apparatus comprising:
a paper tray in which to load at least one printing paper; and
a paper-guiding device disposed at the paper tray to line up and hold the printing paper to match a width of the printing paper, the paper-guiding device including:
at least one of paper guide movably disposed at a paper tray to line up and hold the printing paper,
a guide conveying unit to convey the at least one paper guide along the paper tray, and
a position adjusting unit to control operations of the guide conveying unit, to detect a position of the at least one paper guide and to control a stop position of the at least one paper guide based on the detected position of the at least one paper guide.

23. The image forming apparatus of claim 22, wherein the guide conveying unit comprises:
a motor;
a pinion disposed at a driving shaft of the motor; and
a rack connected to the paper guide to transfer a rotation force of the pinion to the at least one paper guide and being geared on the pinion.

24. The image forming apparatus of claim 22, wherein the position adjusting unit comprises:
a paper detecting sensor to detect whether the printing paper is loaded in the paper tray;
a position detecting sensor disposed at the at least one paper guide to be operated by the printing paper according to a movement of the at least one paper guide to detect the position of the at least one paper guide; and
a controller to control the guide conveying unit to convey the at least one paper guide according to signals output from the paper detecting sensor and the position detecting sensor, and to control the guide conveying unit to control the stop position of the at least one paper guide according to the signals output from the position detecting sensor while the at least one paper guide is being conveyed.

25. The image forming apparatus of claim 24, wherein the position detecting sensor comprises:
a sensing unit disposed at the at least one paper guide and having a light-emitting unit and a light-receiving unit; and
an actuator having a sensing end movably disposed between the light-emitting unit and the light-receiving unit, an operating end having at least one end surface projecting from the at least one paper guide by a first predetermined distance, and a support rod connecting the sensing end and the operating end to be rotatable together.

26. The image forming apparatus of claim 25, wherein the first predetermined distance is in a range of about 0.5 to 1.5 mm.

27. The image forming apparatus of claim 24, wherein the stop position of the at least one paper guide is determined according to whether the position detecting sensor generates a second ON-signal after when the at least one paper guide comes in contact with the printing paper to cause the position detecting sensor to output the second ON-signal, the at least one paper guide is shifted to a first direction by a second predetermined distance shifted to a second direction which is opposite to the first direction by about two times the second predetermined distance, and then shifted to the first direction again by about the second predetermined distance.

28. The image forming apparatus of claim 27, wherein the second predetermined distance corresponds to an allowable line up error of the printing paper.

29. The image forming apparatus of claim 28, wherein the second predetermined distance is in a range of about 2 to 5 mm.

30. An image forming apparatus, comprising:
a paper tray to support a recording medium;
a paper guide movable between a setting position disposed against edges of the recording medium and a waiting position disposed at an end of the paper tray opposite to the setting position; and
a controller to move the paper guide to the setting position when the recording medium is disposed in the paper tray and to move the paper guide to the waiting position when the recording medium is not disposed in the paper tray.

31. A method of guiding at least one printing paper in an image forming apparatus, the method comprising:
determining whether the printing paper are in a paper tray;
determining a position of a paper guide; and
adjusting the position of the paper guide according to the determined position of the paper guide and whether the printing paper are in the paper tray.

32. The method of claim 31, wherein the determining of the position of the paper guide comprises determining the position of the paper guide as one of a setting position in which the printing paper are lined up and held by the paper guide and a non-setting position in which the printing paper are not lined up and held by the paper guide.

33. The method of claim 32, wherein the adjusting of the position of the paper guide comprises:
conveying the paper guide to a first direction when the position of the paper guide is determined as the non-setting position, and when a predetermined time has not elapsed since the image forming apparatus has been turned on and although the position of the paper guide is determined as the setting position;
detecting the position of the paper guide being in contact with the printing paper; and
adjusting a stop position of the paper guide based on the detected position of the paper guide.

34. The method of claim 33, wherein the adjusting of the stop position comprises:
conveying the paper guide to the first direction by a predetermined distance from the detected position of the paper guide;
conveying the paper guide to a second direction by a distance that is more than two times the predetermined distance, where the second direction is opposite direction to the first direction;
conveying the paper guide to the first direction by the predetermined distance;
determining whether the paper guide comes in contact with the printing paper; and
determining whether the paper guide is stopped according to whether the paper guide is in contact with the printing paper.

35. The method of claim 34, wherein the predetermined distance corresponds to allowable line up error of the printing paper.

36. The method of claim 34, wherein the predetermined distance is in a range of about 2 to 5 mm.

37. The method of claim 34, wherein the determining of whether the paper guide is stopped comprises stopping the paper guide when it is determined that the paper guide comes in contact with the printing paper.

38. The method of claim 32, wherein the determining of the position of the paper guide comprises determining the position of the paper guide as one of a waiting position in which the paper guide is in a position to await loading of the printing paper in the paper tray and a non-waiting position in which the paper guide is not in the position to await the loading of the printing paper in the paper tray.

39. The method of claim 38, wherein the adjusting of the position of the paper guide comprises:
conveying the paper guide to a second direction when the position of the paper guide is determined as the non-waiting position; and
detecting whether the paper guide reaches the waiting position; and
stopping the paper guide when the paper guide reaches the waiting position.

40. The method of claim 39, wherein the detecting of whether the paper guide reaches the waiting position comprises detecting whether the paper guide comes in contact with a stopper located at the waiting position.

41. The method of claim 39, further comprising:
determining whether the printing paper is loaded in the paper tray;
conveying the paper guide to a first direction opposite to the second direction when the printing paper is loaded in the paper tray;
detecting the position of the paper guide being in contact with the printing paper; and
adjusting a stop position of the paper guide based on the detected position of the paper guide.

42. A method of an image forming apparatus having a paper tray to support recording medium, and a paper guide movable between a setting position disposed against edges of the recording medium and a waiting position disposed at an end of the paper tray opposite to the setting position, the method comprising:
sensing whether the recording medium are disposed in the paper tray; and
automatically moving the paper guide to the setting position when the recording medium are disposed in the paper tray and automatically moving the paper guide to the waiting position when the recording medium are not disposed in the paper tray.

43. An image forming apparatus, comprising:
a tray on which a recording medium is disposed;
a guide unit disposed on the tray to guide the recording medium; and
a unit to automatically move the guide unit according to a position of the guide unit, a size of the recording medium, and an existence of the recording medium.
